(19) United States
(12) Patent Application Publication
(10) Pub. No.: US 2014/0179021 A1
(43) Pub. Date: Jun. 26, 2014

(54) HIGH THROUGHPUT MICROFLUIDIC DEVICE

(71) Applicant: Luke A. Parkinson, Kensington Park (AU)

(72) Inventor: Luke A. Parkinson, Kensington Park (AU)

(73) Assignee: University of South Australia, Adelaide (AU)

(21) Appl. No.: 13/992,155

(22) PCT Filed: Dec. 6, 2011
(86) PCT No.: PCT/AU2011/001580

§ 371 Date: Mar. 12, 2014

(30) Foreign Application Priority Data
Dec. 6, 2010 (AU) 2010905349

(51) Int. Cl. B01L 3/00

(52) U.S. Cl. CPC B01L 3/502753
USPC 436/177; 422/503

(57) ABSTRACT

A microfluidic element comprising at least one pair of plates, at least one of said plates having an open channel distributed on a surface that is adjacent the other plate in the pair. In use, said plates are releasably clamped together so as to form an enclosed, continuous microfluidic channel between the plates that is suitable for the passage of a fluid.

This patent application claims priority from Australian Provisional Patent Application No. 2010905349 titled “High Throughput Microfluidic Device” and filed 6 Dec. 2010, the entire contents of which are hereby incorporated by reference.

### FIELD

The present invention relates to microfluidic elements that can be stacked to form integrated multiple-element microfluidic devices. The present invention also relates to microfluidic devices containing said elements, and to uses of said elements and devices.

### BACKGROUND

The field of microfluidics typically involves the manipulation of picolitre to microlitre volumes of fluid(s) in channels having height and width that is typically in the range of hundreds of nanometres to hundreds of micrometres. Microfluidic devices incorporating microfluidic channels have been used in a variety of applications, including microreactors, separators, inkjet printers, biochemical assays, chemical synthesis, drug screening, environmental and health monitoring, and immunospecific processes. Microfluidic devices and processes are becoming increasingly popular as they offer a number of advantages over conventional macro-scale devices and processes, such as compact size, automatability, reduced sample volumes, reduced processing times, integratability, increased utility, and ability to perform several processes simultaneously.

Most microfluidic elements are laminates consisting of two or more substrate plates bonded together. The elements that form the fluid networks, such as channels, chambers, wells and the like through which fluids flow are disposed between the substrate plates. For example, U.S. Pat. No. 6,322,753 (Lindberg et al.) and U.S. Pat. No. 5,932,315 (Lum et al.) each describes a microfluidic element composed of juxtaposed plates that are bonded together, wherein one or more of the plates has an etched pattern of grooves on the surface facing the other plate so as to form sealed micro channels when the plates are bonded together. The plates are typically bonded together using an adhesive and/or by thermal bonding.

In an earlier application (WO 2010/022441) there is described a process for extracting an analyte (e.g. a metal ion or complex) from an analyte-containing fluid phase using a microfluidic device. The process includes passing the analyte-containing fluid phase along a first fluid microchannel of a microfluidic extraction device and passing an extractant fluid phase that is at least partially immiscible with the analyte-containing fluid phase along a second fluid microchannel of the microfluidic extraction device. The process results in extraction of the analyte from one phase into another and has some advantages over conventional, “bulk” extraction processes.

Despite their many advantages, commercial success of microfluidic devices and processes has been slow. One reason for this is that microfluidic devices can be difficult and costly to produce due to the high levels of precision required in order to accurately and reliably reproduce the various microscale features of the devices. Other problems with microfluidic devices and processes include clogging of the channels and accumulations of air bubbles that interfere with proper microfluidic system operation.

There is a need for microfluidic devices that are relatively easy to use and/or are scalable and suitable for use on an industrial scale.

### SUMMARY

The present invention arises from research into microfluidic devices for use in industrial scale processes, including (but not limited to) mineral extraction processes. In particular, we have devised a microfluidic device comprising a plurality of microfluidic elements in a configuration that is readily scalable, comparatively easy to set up and use, and/or capable of being used on an industrial scale.

In a first aspect, the present invention provides a microfluidic element comprising at least one pair of plates, at least one of said plates having an open channel distributed on a surface that is adjacent the other plate in the pair wherein, in use, said plates are releasably clamped together so as to form an enclosed, continuous microfluidic channel between the plates that is suitable for the passage of a fluid.

The releasable clamping of the plates (as opposed to more permanent bonding or adhesion of plates in the prior art) may provide a number of advantages, including the ability to separate the plates for cleaning, for blockages to be released, or for plates to be changed.

In some embodiments, adjacent surfaces of each plate have an open channel distributed thereon. When the two plates are clamped together, each of the open channels forms an enclosed microfluidic channel and fluid is able to pass independently through each channel.

In some embodiments, one of the channels on a surface of a first plate in the pair of plates is formed from or lined with a first material, and the channel on a surface of a second plate in the pair of plates is formed from or lined with a second material, wherein the first and second material are different. In some specific embodiments, the first material is a hydrophobic material and the second material is a hydrophilic material.

The use of different materials in each of the channels may be used to control shear distribution in fluids flowing through the channels.

In some embodiments, the microfluidic channel in a first plate in the pair of plates crosses the microfluidic channel in a second plate in the pair of plates to form one or more contact zone(s) in which the fluid passing through one channel comes into contact with the fluid passing through the other channel. This configuration may be used for microfluidic solvent extraction processes in which an interface is formed between two immiscible solvents at the contact zone(s) to enable transfer of a solute, such as a metal ion, from one fluid to the other fluid.

In some embodiments, the microfluidic element comprises a sealing means between the first and second plates. In some embodiments, the sealing means is a projection along the periphery of the channel in at least one of the plates, whereby the projection engages with and is at least partly compressed by the other plate when the plates are clamped together.

In a second aspect, the present invention provides a microfluidic device comprising one or more microfluidic elements as described herein, a housing containing said microfluidic elements, alignment means for aligning said microfluidic elements with one another, compression means for compressing the plates and and/or microfluidic elements, and at least one fluid inlet and at least one fluid outlet.

BRIEF DESCRIPTION OF THE ACCOMPANYING FIGURES

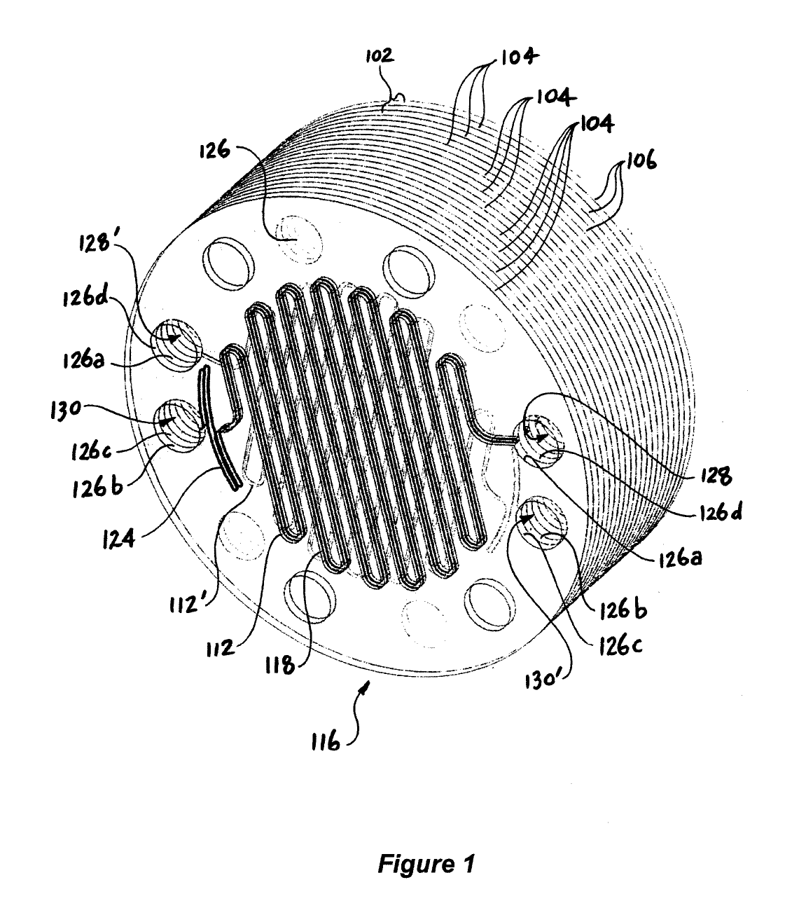

FIG. 1 is an isometric view of a stack of plates in accordance with embodiments of the invention.

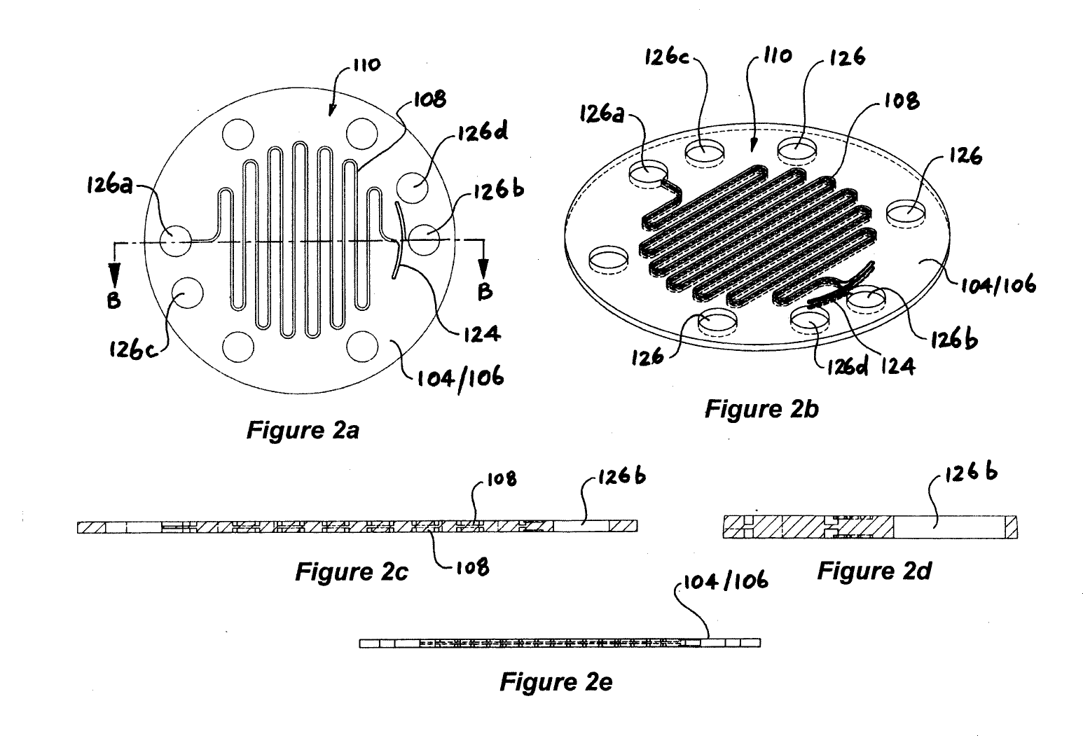

FIG. 2(a) is a plan view of a plate in accordance with embodiments of the invention; (b) is an isometric view of a plate in accordance with embodiments of the invention; (c) is a cross sectional view through B-B of FIG. 2(a); (d) is a part cross sectional view of section C of FIG. 2(c); and (e) is a side view of a plate in accordance with embodiments of the invention.

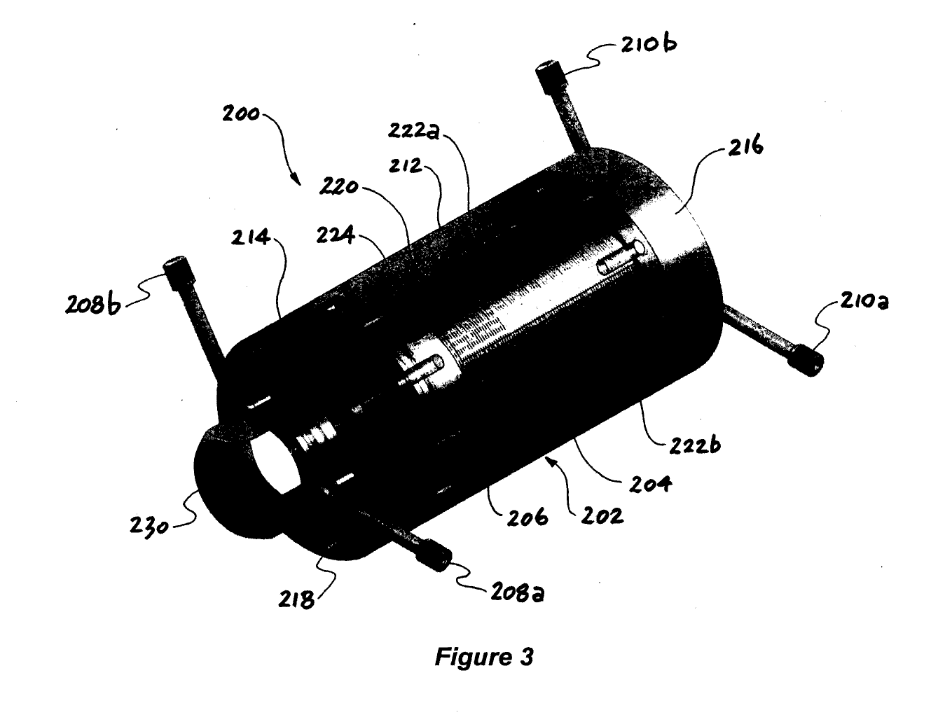

FIG. 3 is an isometric view of a microfluidic device containing a stack of plates in accordance with embodiments of the invention.

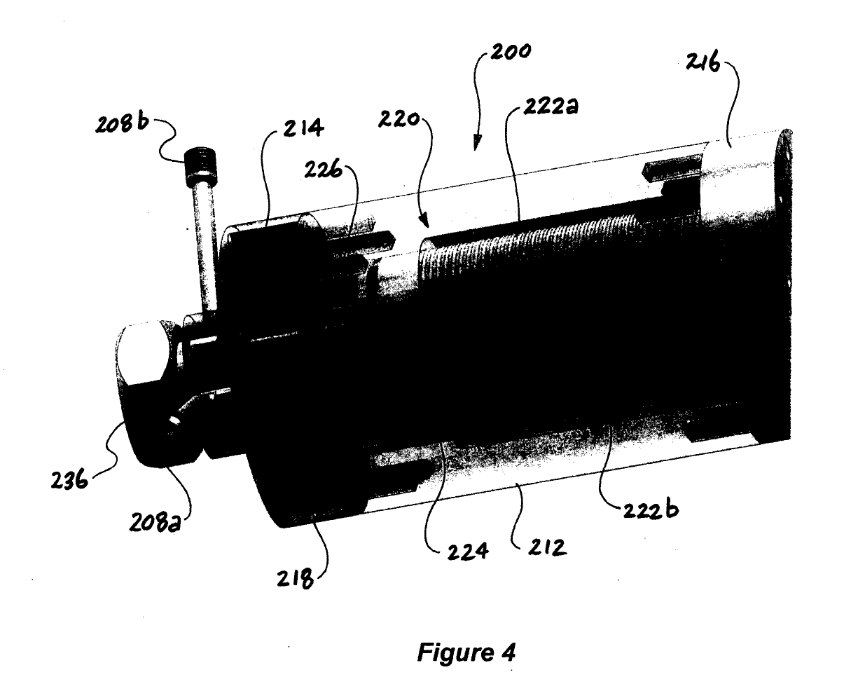

FIG. 4 is a detailed isometric view of a microfluidic device containing a stack of plates in accordance with embodiments of the invention.

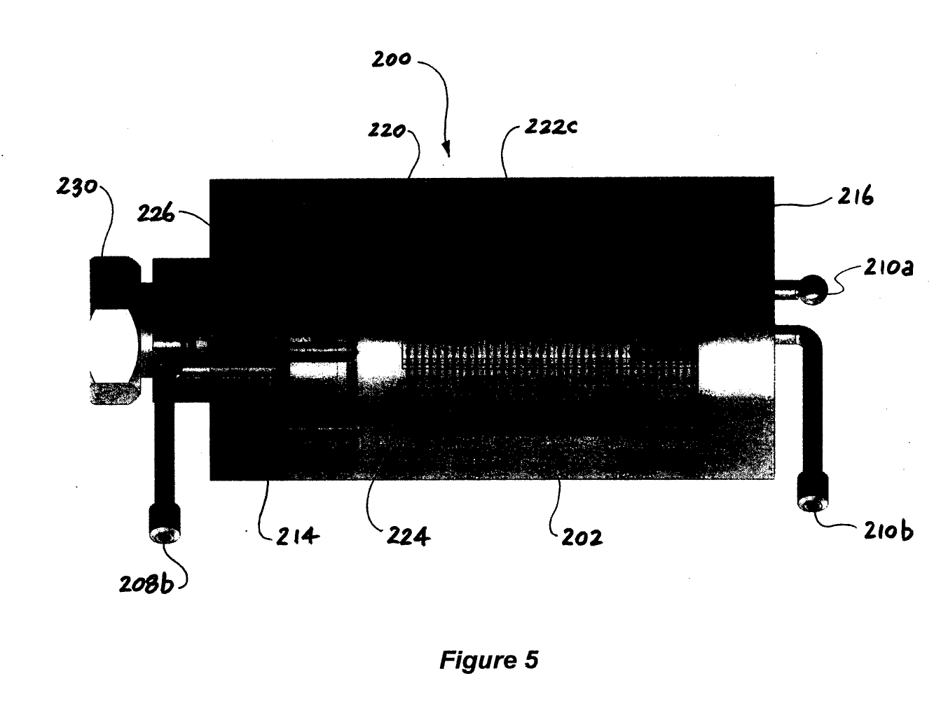

FIG. 5 is a plan view of a microfluidic device containing a stack of plates in accordance with embodiments of the invention.

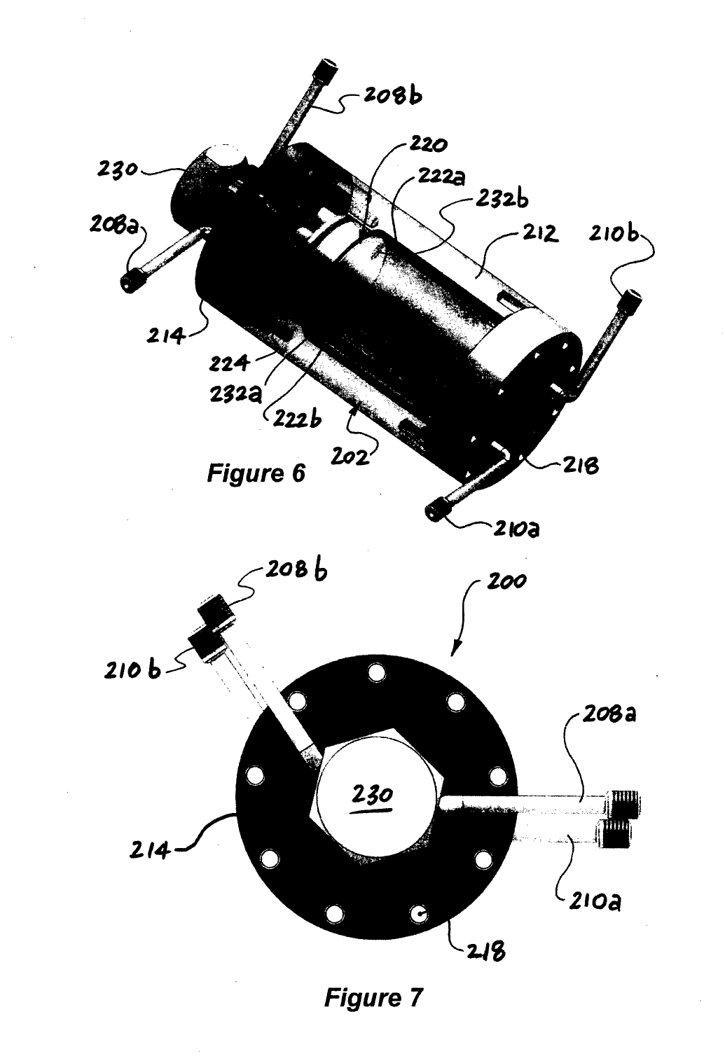

FIG. 6 is an isometric view of a microfluidic device in accordance with embodiments of the invention with plates removed.

FIG. 7 is an end view of a microfluidic device containing a stack of plates in accordance with embodiments of the invention.

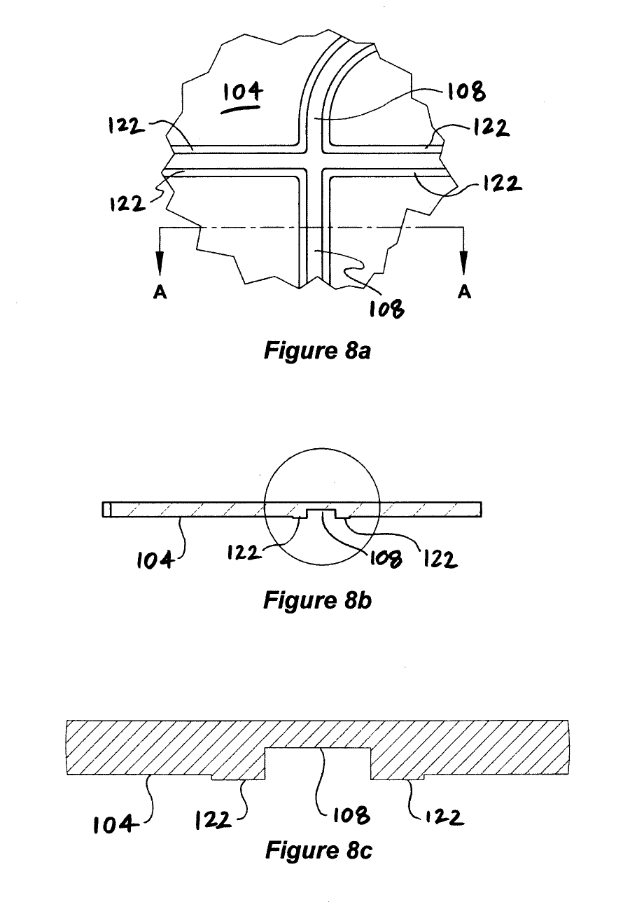

FIG. 8(a) is a plan view of a section of the surface of a plate showing details of the open channel and sealing means; (b) is a cross sectional view through A-A of FIG. 8(a); and (c) is a part cross section of the circled region of FIG. 8(c).

### DETAILED DESCRIPTION OF EMBODIMENTS

For ease of description and understanding of the invention, we will now refer to illustrated embodiments of the invention that are suitable for use in microfluidic solvent-solvent extraction processes. These extraction processes can be used, for example, for extraction of leach solutions, particulate biomaterials, and environmental samples, and also in synthetic chemistry. However, the present invention is not limited to application in solvent extraction processes and it may be utilised in other processes that exploit microfluidic technology, for example simple or complex multilayered droplet formation, drug encapsulation, chemical synthesis, selective filtration, and immunospecific and other biological purification processes.

As best seen in FIG. 1, the present invention provides a microfluidic element 100 comprising at least one pair 102 of plates 104 and 106. At least one of said plates 104 and 106 has an open channel 108 distributed on a surface 110 that is adjacent the other plate. In use, said plates 102 and 104 are releasably clamped together so as to form an enclosed, continuous microfluidic channel 112 suitable for the passage of a fluid.

Whilst it is contemplated in some embodiments of the invention that the surface 110 of only one of the plates 104 or 106 in a pair 102 of plates has an open channel 108 distributed thereon, in the illustrated embodiments the adjacent surfaces 110 of each plate 104 and 106 has an open channel 108 and 108′ distributed thereon. As described in more detail later, when the two plates 104 and 106 in these embodiments are clamped together, each of the open channels 108 and 108′ forms an enclosed microfluidic channel 112 and 112′ and fluid is able to pass independently through each channel 112 and 112′. In some embodiments that are not illustrated, biological or other functional membranes may be included between the plates 104 and 106 to regulate the interaction between the fluids contained in adjacent channels 112 and 112′, or to regulate the passage of fluids or solutes between adjacent channels 112 and 112′.

As used herein, the term “microfluidic”, and variants thereof, means that the element, device, apparatus, substrate or related apparatus contains channels for containing one or more fluids that are typically of nanometre to micrometre dimensions or channels of larger dimensions but containing fluid control features that are of nanometre to micrometre dimensions. A network of microfluidic elements and/or devices connected together may contain a total volume of fluid in the range of millilitres to litres.

In the illustrated embodiments, the plates 104 and 106 are thin, circular discs that are formed from a suitable material. Materials suitable for the manufacture of plates for microfluidic elements are known in the art and may be chosen based on considerations such as cost, inertness or reactivity toward fluids and other materials that will be in contact with the discs, etc. Whilst it is envisaged that the plates 104 and 106 could be manufactured from any suitable material, some examples of suitable materials include metal (e.g. stainless steel, copper), silicon, glass, quartz, and polymers. Suitable polymeric materials include polydimethylsiloxane (PDMS), polytetrafluoroethylene (PTFE), other perfluoropolyether (PFPE) based elastomers, polymethylmethacrylate (PMMA), silicone, and the like. Furthermore, whilst the plates 104 in the illustrated embodiments are circular in plan view it is envisaged that they can be other shapes in plan view, such as square, rectangular, etc.

The plates 104 and 106 have a thickness adequate for maintaining the integrity of the microfluidic structure assembly. In the illustrated embodiments, the plates 104 and 106 are about 1 mm thick.

The open channel 108 (and/or any other microfluidic features on the surface 110) can be formed in the surface 110 using any of the techniques for forming fluid microchannel networks that are known in the art. For example, the patterned plates 104 and 106 can be fabricated using standard photolithographic and etching procedures including soft lithography techniques (e.g. see Shi J., et al., Applied Physics Letters 91, 153114 (2007); Chen Q., et al., Journal of Microelectromechanical Systems, 16, 1 193 (2007); or Duffy et al., Rapid Prototyping of Microfluidic Systems in Poly(dimethylsiloxane), Anal. Chem., 70 (23), 4974-4984 (1998)), such as near-field phase shift lithography, microtransfer molding, solvent-assisted microcontact molding, microcontact printing, and other lithographic microfabrication techniques employed in the semiconductor industry. Direct machining or forming techniques may also be used as suited to the particular device. Such techniques may include hot embossing, cold stamping, injection moulding, direct mechanical milling, laser etching, chemical etching, reactive ion etching, physical and chemical vapour deposition, and plasma sputtering. The particular methods used will depend on the function of the particular microfluidic network, the materials used as well as ease and economy of production.

In the illustrated embodiments, the open channel 108 on the surface 110 of a first plate 104 in a pair 102 of plates is formed from or lined with a first material, and the open channel 108′ on the surface 110′ of a second plate 106 in the pair 102 is formed from or lined with a second material, the first and second materials being different. As a result of the use of different materials the plates 104 and 106 are depicted in the Figures with different shading. The first material may be a hydrophobic material and the second material may be a hydrophilic material. In this way, when the first 104 and second 106 plates are clamped together to form a microfluidic element 100, one of the microfluidic channels 112 thus formed has an inner surface that is at least partly hydrophobic and the other microfluidic channel 112′ thus formed has an inner surface that is at least partly hydrophilic. In the illustrated embodiments, the first plate 104 is formed from polytetrafluoroethylene and provides a hydrophobic surface in the open channel 108 formed in the surface 110, whilst the second plate 106 is formed from glass and provides a relatively hydrophilic surface in the open channel 108′ formed in the surface 110′.

Having the open channel 108 on the surface 110 of a first plate 104 formed from or lined with a first material, and the open channel 108′ on the surface 110′ of a second plate 106 formed from or lined with a second material may assist in maintaining stable flows of two different fluid phases (e.g. a hydrophilic phase and a hydrophobic phase) in the channels 112 and 112′ as is required for solvent extraction processes. For example, the hydrophobic/hydrophilic inner surfaces may assist in maintaining stability and/or separation between an aqueous solvent such as water and an immiscible organic solvent, such as a hydrocarbon solvent, in a microfluidic solvent extraction process due to the increase in surface free energy required for a non-polar liquid to wet a high energy (hydrophilic) solid such as glass, or for a polar solvent to form an interface with a solid with low surface free energy (hydrophobic) such as polytetrafluoroethylene. This acts to hold the interface between two immiscible liquids when they are in contact with one another because deformation of the liquid-liquid interface is resisted by the increase in surface free energy required to increase the area of the interface between the two immiscible liquids. This is known as Laplace or capillary pressure, and provides a pressure buffer to resist interfacial deformation and droplet formation due to pressure differences between the two adjacent liquid phases.

As best seen in FIGS. 1 and 2, each of the plates 104 and 106 has the open channel 108 and 108′ formed on both surfaces of each plate. The configuration of channels 108 and 108′ on each surface as well as on each plate is the same. It is envisaged that different plates 104 and 106 may have open channels 108 and 108′ that are different configurations. However, having the same configuration of channels on each surface as well as on each plate 104 and 106 simplifies fabrication of the plates and therefore minimises the cost of manufacturing the plates.

In use, each of the plates 104 and 106 is releasably clamped together to form an integral microfluidic element 100. Whilst there only needs to be a pair 102 of plates 104 and 106 to form a microfluidic element 100, an advantage of the present invention is that more than one pair of plates can be stacked one atop the other to form a stack 116 of microfluidic elements 100. Equivalent plates in each pair of plates 102 in stack 116 is equivalent in terms of configuration and materials. Thus, in the embodiment shown in FIG. 1, the darker shaded plates 104 are formed from PTFE and are hydrophobic whilst the lighter shaded plates 106 are formed from glass and are hydrophilic. The PTFE plates 104 are interleaved with the glass plates 106.

The plates in a pair or stack of plates may be clamped together using a clamping means 114 as described in more detail later. The plates 104 and 106 are releasably clamped together which means that the clamping means 114 can be released and the plates 104 and 106 separated from one another. This allows for the plates and microfluidic channels to be cleaned, for blockages to be released, for plates to be changed for example to a different material for a different application etc. without the need to shut the device down for lengthy periods. This is advantageous over prior art microfluidic elements that are formed by adhering or fusing the plates together irreversibly.

As best seen in FIG. 1, adjacent plates 104 and 106 are rotated 205 degrees with respect to each adjacent plate. This means that the open channels 108 and 108′ on adjacent surfaces 110 and 110′ of adjacent plates form a criss-cross pattern in which part of each open channel 108 and 108′ is enclosed by the surface 110′ and 110 respectively of the adjacent plate to form enclosed channels 112 and 112′. Open channel 108 crosses the open channel 108′ of an adjacent plate at several points to form contact zones 118. In the contact zones 118, the fluid passing through one channel 112 comes into contact with the fluid passing through the other channel 112′. At each of the contact zones 118, an interface is formed between the fluids and this enables a solute to transfer from one fluid to the other. However, the contact zones 118 are interspersed with enclosed channels 112 and 112′ in which the respective fluids pass without contact with the fluid in the adjacent plate. This configuration allows stable two phase flows to be maintained whilst also allowing for zones of contact between the fluids for the purpose of solute transfer. The use of different materials in adjacent channels 112 and 112′ in alternate plates also assists in maintaining stable flows of the two different fluids in the contact zones as described earlier. The crossed-channel arrangement just described may be useful in a number of other microfluidic applications. For example, the arrangement could be used to form droplet-generation nozzles in applications when there is a significant pressure difference between the opposing channels.

The plates 104 and 106 at the ends of each stack 116 may not have any channels 108 and 108′ formed on an outermost surface so as to exclude fluid flow through channels where there is no interaction with the flow through an adjacent plate.

The microfluidic element 100 further comprises a sealing means 120 between the first 104 and second 106 plates. Whilst it is contemplated that any form of sealing means could be utilised in the microfluidic element 100, an advantageous sealing means is shown in the illustrated embodiments in which the sealing means is in the form of a projection 122 that is formed along the periphery of the open channels 108 and/or 108′ in at least one of the plates 104 or 106. The projection 122 engages with and is at least partly compressed by the other plate when the plates 104 and 106 are clamped together, thereby forming a seal along the periphery of the microfluidic channel 112 and/or 112′. Details of the projection 122 can be seen in more detail in FIG. 8 which shows a section of a plate 104 with intersecting open channels 108 and a projection 122 that is formed along the periphery of each channel 108 and projects outwardly from the surface of the plate 104.

The microfluidic channel 112 shown in the illustrated embodiments follows a serpentine path in plan view. In this way, the path length of the microfluidic channel 112 is maximised. However, the length of the microfluidic channel 112 can be varied to adapt to the desired application. The length of the microfluidic channel 112 may be from about 0.1 mm to about 400 mm. In the illustrated embodiments, the microfluidic channel 112 is about 400 mm in length.

The cross sectional dimensions of the microfluidic channel 112 or 112′ can vary depending on the specific application of the microfluidic device or element. For example, a microfluidic structure assembly suitable for solvent extraction processes may have a microchannel with a diameter of about 50 microns to about 500 microns. In the illustrated embodiments, the microfluidic channel is square in cross section and has a depth and width of about 400 microns. The cross sectional shape of the microfluidic channel need not be square and, for example, it could be circular, etc.

As best seen in FIGS. 1, 2(a) and 2(b), the microfluidic channels 112 and 112′ include a channel restriction zone 124 at or adjacent an outlet end of the channel 110. In the channel restriction zone 124, the cross sectional dimensions of the channel are significantly smaller than those of the main channel. The channel restriction zone 124 chokes the overall flow through the main channel 112 and 112′ because the hydrodynamic resistance in the channel restriction zone 124 is large relative to the resistance in the main channel. The overall effect is that the main channel 112 and 112′ operates at higher pressure, which allows more rapid dissipation of pressure fluctuations and flow instabilities and may increase the efficiency of solvent extraction or other chemical processes.

Each of the plates 104 and 106 contains a plurality of through holes 126 which pass through the entire depth of the plate. At least some of the through holes 126 in each plate 104 and 106 act as supply and exhaust bores. Thus, in each plate 104 and 106 there is one through hole 126a that is in fluid communication with an inlet end of the microfluidic channel 112 and this through hole forms part of a supply bore 128 when multiple microfluidic elements 100 are stacked one adjacent the other, as explained in more detail later. Also in each plate 104 and 106 there is one through hole 126b that is in fluid communication with an outlet end of the microfluidic channel 112 and this through hole forms part of an outlet bore 130 when multiple microfluidic elements 100 are stacked one adjacent the other. The through holes 126 also serve as alignment structures and permit correct alignment of adjacent plates 105 and 106 in each pair 102 of plates as well as adjacent microfluidic elements 110 in a stack 116 of microfluidic elements. Other through holes, or those which act as the fluid connections themselves may be used for the inclusion of additional functionalities to the microfluidic assembly. For example, a charged pin slidably or removably inserted through one or more of the aligned through holes 126 may be used for an electrodeposition step subsequent to the metal stripping through solvent extraction.

More specifically, each of the plates 104 and 106 contains two sets of diametrically opposed through holes 126a/b and 126c/d. When the plates 104 and 106 are assembled to form a stack 116, the through holes 126a and 126b of each of the first plates 104 in the stack form a supply bore 128 and an outlet bore 130, respectively for the first plates. In use, a first fluid is pumped into the supply bore 128. The pressure applied forces the liquid through the enclosed microfluidic channels) 112 in each plate 104 and the fluid then exits the channel(s) 112 into the outlet bore 130. The through holes 126d and 126c in second plate 106 are not connected to the channel 112′ in that plate and, therefore, when the plates 104 and 106 are interleaved as shown in FIG. 1, the through holes 126d and 126c in plate 106 are aligned with the through holes 126a and 126b respectively in the first plate 104 to form the supply bore 128 and outlet bore 130 but the fluid passing along the supply bore 128 does not enter channel 112′.

Likewise, when the plates 104 and 106 are assembled to form a stack 116, the through holes 126a and 126b of each of the second plates 106 in the stack form a supply bore 128′ and an outlet bore 130′, respectively for the second plates. In use, a first fluid is pumped into the supply bore 128′. The pressure applied forces the liquid through the enclosed microfluidic channel(s) 112′ in each plate 106 and the fluid then exits the channel(s) 112′ into the outlet bore 130′. The through holes 126d and 126c in first plate 104 are not connected to the channel 112 in that plate and, therefore, when the plates 104 and 106 are interleaved as shown in FIG. 1, the through holes 126d and 126c in plate 104 are aligned with the through holes 126a and 126b respectively in the second plate 106 to form the supply bore 128′ and outlet bore 130′ but the fluid passing along the supply bore 128′ does not enter channel 112.

In this embodiment, the plates 104 and 106 are arranged with respect to one another in a ‘counter flow’ arrangement whereby the inlet to the channel 112 in the first plate 104 is positioned opposite the inlet to the channel 112′ in the second plate 106. Thus, the fluids travel along the channels 112 and 112′ in substantially opposing directions. In practice, this arrangement is not necessary for the function of the device, however solvent extraction rates and the stability of the liquid-liquid interface may be improved using this configuration.

The microfluidic element 100 individually or in the form of a stack 116 is suitable for use in a microfluidic device, such as a microfluidic solvent extraction device. Thus, the present invention also provides a microfluidic device 200 comprising one or more microfluidic elements 100, a housing 202 containing said microfluidic elements 100, alignment means 204 for aligning said microfluidic elements with one another, compression means 206 for compressing the plates 102 and 104 and/or microfluidic elements 110, an inlet 208 and an outlet 210. As shown in FIGS. 3 to 7, the housing 202 is circular in cross section and comprises a wall 212, a first end cap 214 and a second end cap 216. In the illustrated embodiments, the end caps 214 and 216 are formed separately from the housing wall 212 and fixed thereto using a fastener such as one or more bolts 218. Preferably, at least one of the end caps 214 and 216 is capable of being detached from the housing wall 212 so as to provide access to the interior of the housing 202. It is contemplated that other configurations of housing that differ from those shown in the illustrated embodiments could also be utilised. For example, one of the end caps could be integrally formed with the housing wall or other fluid ports included to supply or drain the free space inside the housing or to accommodate additional fixtures such as electrode pins.

The end caps 214 and 216 and housing 202 may be formed from any suitable material, including glass, metal, metal with a protective coating or liner, and polymeric material. In the illustrated embodiments, the housing 202 is transparent and this allows for easy visual inspection of the stack 116 contained therein.

The housing 202 is a sealed cylinder and this serves several purposes. It may act as a reservoir for any fluids that may leak from the microfluidic elements 100, allowing these fluids to be harvested through an appropriate fluid port and recycled. This is of particular value where the fluids contained are either hazardous or valuable. The free space inside the housing 202 may also incorporate a fluid port providing fluid communication to the outside of the housing so that this space may serve as an alternative or additional means of inlet or outlet fluid connection to a microfluidic network.

The alignment means 204 is housed within the housing 202. In the illustrated embodiments, the alignment means 204 is in the form of a sleeve 220 into which the microfluidic elements 100 fit. The diameter of the sleeve 220 is slightly larger than the diameter of the plates 104 and 106 so that the plates 104 and 106 or microfluidic elements 100 can be inserted into the sleeve 220 and form a snug fit therein. This assists in aligning the plates 104 and 106 and microfluidic elements 100.

The sleeve 220 is aligned coaxially with the housing 202 and is formed by a plurality of sleeve sections 222a-c. The sleeve sections 222a-c are fixed to the second end cap 216 and extend therefrom so as to form the sleeve 220.

Whilst the alignment means 204 is a sleeve 220 in the illustrated embodiments, it is envisaged that other forms and embodiments of alignment means could also be used. Indeed, any structure that permits the alignment of multiple microfluidic elements 100 could be used. For example, the alignment means could be two or more posts that extend from an end cap and positioned so that the posts can be inserted through appropriately positioned through holes 126 in the plates 104 and 106 and/or microfluidic elements 100.

The compression means 204 is in the form of a piston 224 that is shaped to fit into the sleeve 220 and compress the microfluidic elements 100 contained therein so that all of the plates 104 and 106 are compressed into sealing engagement with one another. The piston 224 is attached to a screw 226 which is threadingly engaged in a correspondingly threaded aperture 228 in the first end cap 214. The screw 226 is attached to a nut 230 which can be used to turn the screw 226 and either compress all of the plates 104 and 106 together and/or release the compression on the plates 104 and 106 so that they can be cleared of blockages by purging between the plates into the space surrounding the stack, cleaned or so that individual plates can be removed. An advantage of this form of the invention is that it is a relatively simple process to move the piston 224 up, place one or more plates 104 and 106 in the sleeve 220 and then move the piston 224 down to compress the plates into engagement with one other. Furthermore, the range of movement of the piston 224 is such that the sleeve does not have to be completely filled with plates 104 and 106 and so, for example, the sleeve 220 may be half filled with interleaved plates 104 and 106 and the piston moved down into engagement with the elements. Thus, the height of the stack 116 can easily be altered without the need to change the geometry of the design of the device and, as such, the device is readily up- or down-scalable on a small scale. Furthermore, housings 202 of different lengths may also be used for up-scaling or down-scaling.

The device 200 includes two inlets 208a and 208b, and two corresponding outlets 210a and 210b. The inlets 208a and 208b extend from the exterior of the device through the end cap 214, with each of them terminating at an inlet port 232a and 232b. When the piston 220 is in contact with microfluidic elements 100 the inlet ports 232a and 232b are aligned and in fluid communication with supply bores 128 and 128′, respectively. The inlet ports 232a and 232b may be surrounded with a suitable seal so that a fluid tight seal is formed when the ports contact the end most plate of the stack 116. Any suitable seal can be used for this purpose, such as an elastomeric ring.

Similarly, the outlets 210a and 210b extend from the exterior of the device through the second end cap 216 and each of them terminates at an outlet port 234a and 234b. The outlet ports 234a and 234b are aligned and in fluid communication with outlet bores 130 and 130′, respectively. The outlet ports 234a and 234b may be surrounded with a suitable seal so that a fluid tight seal is formed when the ports contact the end most plate of the stack 116. Any suitable seal can be used for this purpose, such as an elastomeric ring.

In use, a source of a first fluid is connected to inlet 208a and a source of a second fluid is connected to inlet 208b. In the case of solvent extraction, either of the first or second fluids may contain extractable quantities of a target analyte, such as a target metal ion or metal complex. Both fluids are pumped into the respective inlets using standard apparatus and processes known for this purpose. Each fluid then passes along a respective supply bore 128 and 128′. The first fluid passes from supply bore 128 through the microfluidic channel(s) 112 in each of plates 104. Similarly, the second fluid passes from supply bore 128′ through the microfluidic channel(s) 112′ in each of plates 106. The fluids come into contact with one another at the contact zones 118. In the embodiments shown in FIG. 1, there are 74 contact zones. In the contact zones an interface is formed between the immiscible fluids and transfer of the analyte from one fluid to another occurs. Each fluid passes through the microfluidic channel of every second plate. As such, all of the equivalent plates 104 are plumbed in parallel and therefore the failure of one plate in a stack will not substantially affect the other equivalent plates in the stack. The fluids then pass through the restriction zone 124 and into the respective outlet bores 130 and 130′ and out of the device through the outlet ports 234a and 234b where they are able to be collected. In some embodiments, each outlet port of one device 200 may be connected to the inlet ports in second device 200′ so that further extraction may be carried out in the second device. A plurality of devices may be connected in series in this way to improve the extraction efficiency of an extraction process.

For some applications, the plates 104 and/or 106 may be able to be heated by electrical resistance, conduction or other means for generation of drops from viscous fluids, or electrified to enable the device to be used in other microfluidic applications such as electrophoretic separation. Pins inserted through the through-holes 126 common to each microfluidic element 100 may be electrically connected to individual plates 104 and 106 or elements 100.

Depending on the application of the microfluidic structure assembly, the size, thickness, and other dimensional characteristics of the plates, as well as the size, shape, and other dimensional characteristics of the microchannel, chambers, microanchors, microdepressions, microprojections, and the like, can vary to adapt to the application.

It will be evident from the foregoing description that the present invention also provides a process for extracting a solute from a feedstock solution containing the solute, the process comprising:
passing the feedstock solution through a first microfluidic channel of a microfluidic element as described herein;
passing an extractant solution through a second microfluidic channel of the microfluidic element, wherein the first and second microfluidic channels cross at at least one contact zone at which the feedstock solution and the extractant solution contact one another to allow transfer of at least some of the solute from the feedstock solution to the extractant solution; and
separating the extractant solution from the feedstock solution.

The feedstock solution may be an organic solvent or an aqueous solvent containing the solute and the extractant solution may be a solvent that is immiscible or partly miscible with the feedstock solution.

Solutes that can be extracted by this process include: biological molecules, such as amino acids, peptides, proteins, nucleotides, polynucleotides, etc; metals; small organic molecules; fatty acids; lipids; environmental contaminants, etc. Any liquid-liquid extraction method that is carried out on a bulk scale may be carried out using the microfluidic element described herein (see, for example, Rydberg, J. “Solvent extraction principles and practice” CRC Press, 2004).

The present invention also provides the use of a microfluidic element as described herein in a solvent extraction process.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

All publications mentioned in this specification are herein incorporated by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

1. A microfluidic element comprising at least one pair of plates, at least one of said plates having an open channel distributed on a surface that is adjacent the other plate in the pair wherein, in use, said plates are releasably clamped together so as to form an enclosed, continuous microfluidic channel between the plates that is suitable for the passage of a fluid and wherein the microfluidic element comprises a sealing means between the pair of plates, the sealing means comprising a projection along the periphery of the channel in at least one of the plates, whereby the projection engages with and is at least partly compressed by the other plate when the plates are clamped together.

2. The microfluidic element according to claim 1, wherein adjacent surfaces of each plate have an open channel distributed thereon and when the two plates are clamped together, each of the open channels forms an enclosed microfluidic channel and fluid is able to pass independently through each channel.

3. The microfluidic element according to claim 1, wherein one of the channels on a surface of a first plate in the pair of plates is formed from or lined with a first material, and the channel on a surface of a second plate in the pair of plates is formed from or lined with a second material, wherein the first and second material are different.

4. The microfluidic element according to claim 3, wherein the first material is a hydrophobic material and the second material is a hydrophilic material.

5. The microfluidic element according to claim 1, wherein the microfluidic channel in a first plate in the pair of plates crosses the microfluidic channel in a second plate in the pair of plates to form one or more contact zones in which the fluid passing through one channel comes into contact with the fluid passing through the other channel.

6. The microfluidic element according to any one of the preceding claims claim 1, wherein each microfluidic channel comprises a restriction zone at or adjacent an outlet end thereof.

7. A microfluidic element comprising at least one pair of plates, at least one of said plates having an open channel distributed on a surface that is adjacent the other plate in the pair and a projection along the periphery of the open channel wherein, in use, said plates are releasably clamped together so as to form an enclosed, continuous microfluidic channel between the plates that is suitable for the passage of a fluid and the projection engages with and is at least partly compressed by the other plate when the plates are clamped together.

8. A microfluidic device comprising one or more microfluidic elements according to claim 1, a housing containing said microfluidic elements, alignment means for aligning said microfluidic elements with one another, compression means for compressing the plates and and/or microfluidic elements, an inlet and an outlet.

9. The microfluidic device according to claim 8, wherein the housing is sealed and free space inside the housing acts as a reservoir for any fluids that may leak from the microfluidic elements and/or as an alternative or additional means of inlet or outlet fluid connection to a microfluidic network.

10. The microfluidic device according to claim 8, wherein the compression means is in the form of a piston that is shaped to compress the microfluidic elements so that all of the plates are compressed into sealing engagement with one another.

11. (canceled)

12. A process for extracting a solute from a feedstock solution containing the solute, the process comprising:
passing the feedstock solution through a first microfluidic channel of a microfluidic element of claim 1;
passing an extractant solution through a second microfluidic channel of the microfluidic element, wherein the first and second microfluidic channels cross at least one contact zone at which the feedstock solution and the extractant solution contact one another to allow transfer of at least some of the solute from the feedstock solution to the extractant solution; and
separating the extractant solution from the feedstock solution.

13. (canceled)

14. The process according to claim 12, wherein adjacent surfaces of each plate have an open channel distributed thereon and when the two plates are clamped together, each of the open channels forms an enclosed microfluidic channel and fluid is able to pass independently through each channel.

15. The process according to claim 12, wherein one of the channels on a surface of a first plate in the pair of plates is formed from or lined with a first material, and the channel on a surface of a second plate in the pair of plates is formed from or lined with a second material, wherein the first and second material are different.

16. The process according to claim 15, wherein the first material is a hydrophobic material and the second material is a hydrophilic material.

17. The process according to claim 12, wherein the microfluidic channel in a first plate in the pair of plates crosses the microfluidic channel in a second plate in the pair of plates to form one or more contact zones in which the fluid passing through one channel comes into contact with the fluid passing through the other channel.

18. The process according to claim 12, wherein each microfluidic channel comprises a restriction zone at or adjacent an outlet end thereof.
